(19) United States
(12) Patent Application Publication
(10) Pub. No.: US 2006/0167948 A1
(43) Pub. Date: Jul. 27, 2006

(54) Detection of computer system malware

(76) Inventor: Gian-Nicolas Pietravalle, San Diego, CA (US)

Correspondence Address: Gian-Nicolas Pietravalle, 6651 Delfern St, San Diego, CA, 92120, US

(21) Appl. No.: 11/042,629

(22) Filed: Jan. 26, 2005

(51) Int. Cl. G06F 17/30; G06F 12/00; G06F 17/00

(52) U.S. Cl. 707/200

(57) ABSTRACT

The invention contains a new way to detect computer system malware. By detecting the file extension, not the file itself, a more effective detection method is produced. This method allows new, unknown malware to be detected immediately.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

The field of endeavor, which our invention pertains, is in computer technology.

### DESCRIPTION OF THE RELATED ART

Current processes for detecting computer system malware involve using a database of known malware for detection purposes. This process is flawed in that only malware that has already been discovered and analyzed can be detected. This method does not protect a computer system from new, unknown malware.

### BRIEF SUMMARY OF THE INVENTION

The general idea of our invention is to protect computer systems from being infected by both known and unknown malware. As previously stated, our process of detection allows new, unknown malware to be detected immediately. Current methods of detection prevent new malware from being detected immediately until it has been analyzed and added to a database of “known malware”.

### BRIEF DESCRIPTION OF THE SEVERAL VIEWS OF THE DRAWING

“Not Applicable”

### DETAILED DESCRIPTION OF THE INVENTION

Our process of detecting computer system malware involves monitoring a computer system's file system for the creation, deletion, modification or renaming of file or files containing a specific extension. These extensions include but are not limited to: .exe, .scr, .dll, .ocx, .hta and others. Monitoring a computer system file system can be achieved using any hardware or software designed to monitor a file system for the creation, deletion, modification or renaming of files. By limiting the monitoring of the creation, deletion, modification or renaming of file or files to the file extension(s) specified, detection of malware can occur.

The process of creating our invention requires a software or hardware component capable of monitoring a computer systems file system for changes based on file extension. These file system changes include, but are not limited to, the creation, deletion, modification or renaming of any file or files in the file system being monitored. When a file extension matching the malware profile set is detected, the file may be treated any number of ways including deletion, renaming, or blocking of file execution.

Current methods of detection prevent new malware from being detected immediately until it has been analyzed and added to a database of “known malware”. This “lag” can create a period of several hours to several days before a new, previously undiscovered piece of malware can be detected by current malware scanners. Our process allows most pieces of malware, whether new or old, to be detected immediately by detecting the file extension used by malware. Current malware files use extensions such as: .exe, .dll, .ocx, and others, allowing them to be installed and run within a computer system. By detecting the extension, not the file itself, detection can be more effective, thus providing a higher level of computer system protection.

1. What I claim as my invention is a new way to detect computer system malware.
